(19) United States
(12) Patent Application Publication
(10) Pub. No.: US 2025/0344831 A1
(43) Pub. Date: Nov. 13, 2025

(54) DEVICE FOR STORING AND DISPENSING AT LEAST TWO COSMETIC PRODUCTS

(71) Applicant: L'OREAL, Paris (FR)

(72) Inventors: JinSeok KIM, Shanghai (CN); Chunjie LI, Shanghai (CN); Yi SHI, Shanghai (CN); Eric LE CUDONNEC, Shanghai (CN)

(73) Assignee: L'OREAL, Paris (FR)

(21) Appl. No.: 18/869,448

(22) PCT Filed: May 31, 2022
(86) PCT No.: PCT/CN2022/096181

§ 371 Date: Nov. 26, 2024

(51) Int. Cl. A45D 40/24; A45D 34/04; A45D 40/26

(52) U.S. Cl. CPC A45D 40/24; A45D 34/04; A45D 40/26; A45D 2200/056; A45D 2200/058

(57) ABSTRACT

A device for storing and dispensing at least two cosmetic products comprises: a main body defining a first reservoir and a second reservoir; a first pump configured to be triggered along a first triggering axis; a second pump configured to be triggered along a second triggering axis parallel to the first triggering axis; a nozzle movably arranged relative to the main body and; and an applicator operable to move the nozzle relative to the main body parallel to the first triggering axis and the second triggering axis, from a resting position into a discharging position; wherein the applicator comprises: a pressing plate configured to be pressed by a user; a base plate configured for pushing the nozzle; and a stem portion fixed on one end to the pressing plate at a central region of the pressing plate, and fixed on the other end to the base plate, the stem portion extends in parallel to the first triggering axis and the second triggering axis; wherein the projected area of the pressing plate in a projection plane perpendicular to the first triggering axis and the second triggering axis is 20%-50% of the projected area of the base plate in the projection plane.

### FIELD OF INVENTION

The present invention generally relates to a device for storing and dispensing at least two cosmetic products, in particular in liquid or paste form.

### BACKGROUND

Some mixtures of cosmetic products are unstable and therefore are active in only a quite limited period of time. This may be the case for example when a total whitening care product is mixed with deep whitening product, antioxidation product and outer layer color correction and protection.

Some mixtures have a higher viscosity than the viscosity of each cosmetic product from which they are prepared, the viscosity of the mixture being so high that the mixture is unable to flow properly through a distribution channel.

For these reasons, the above kind of mixture is not suitable to be stored and dispensed to the user with a conventional container device having only one single reservoir. Accordingly, cosmetic devices capable of storing and simultaneously dispensing multiple kinds of cosmetic contents have been developed, so that the mixing is not performed until immediately before the mixture is applied to the user.

U.S. Pat. No. 5,967,372A discloses a bottle for metered distribution of fluid products comprising a reservoir with two chambers for two products to be dispensed simultaneously, each chamber being provided with a pump secured on a collar. The bottle further comprising a push button provided with an outlet opening and in contact with actuating rods of the pumps.

U.S. Pat. No. 11,034,503B1 discloses a mixing container comprising a first container, a second container, a first discharge device, a second discharge device, a push button, and cap member. The push button is coupled to the cap member so as to move down and to simultaneously actuate the first and second discharge device when pressed by user.

One disadvantage of the known devices is that the button or component for simultaneously actuating two or more pumps may tilt when pressed by the user. As a result, one of the pumps may be pressed down by a further distance as compared to another one of the pumps. Since the device is designed to deliver a different cosmetic products in an amount that correspond to a desired ratio when the actuating rod of all of the pumps are displaced by a same distance, the tilt of the button results in deviation from the desired, predetermined ratio of the amount of different cosmetic products dispensed.

Therefore, there is a need for a device that can store at least two cosmetic products and that can dispense multiple cosmetic products with a proper ratio while still being easy to use.

### SUMMARY

It is an object of the present invention to provide an improved device for storing and dispensing at least two cosmetic products, wherein multiple cosmetic products can be easily dispensed with a proper ratio. The at least two cosmetic products can then be mixed so as to form a mixture.

A cosmetic product may be a product as defined in EC Regulation N° 1223/2009 of the European Parliament and the Council dated Nov. 30, 2009, relating to cosmetic products.

The mixture of the at least two cosmetic products may be e.g. a skin care product, a make-up product, and/or a hair coloration product, etc.,

According to one aspect of the present invention, there is provided a device for storing and dispensing at least two cosmetic products, comprising: a main body defining a first reservoir configured to contain a first cosmetic product and a second reservoir configured to contain a second cosmetic product; a first pump configured to dispense the first cosmetic product from the first reservoir when triggered along a first triggering axis; a second pump configured to dispense the second cosmetic product from the second reservoir when triggered along a second triggering axis, the second triggering axis being parallel to the first triggering axis; a nozzle defining a first outlet in fluid communication with the first pump through a first channel and a second outlet in fluid communication with the second pump through a second channel, wherein the nozzle is movably arranged relative to the main body and biased towards a resting position relative to the main body by a biasing means; an applicator operable to move the nozzle relative to the main body parallel to the first triggering axis and the second triggering axis, from a resting position, in which the first pump and the second pump are at rest, into a discharging position, in which the first pump and the second pump are triggered, against the action of the biasing means; wherein the applicator comprises: a pressing plate configured to be pressed by a user; a base plate configured for pushing the nozzle; a stem portion fixed on one end to the pressing plate at a central region of the pressing plate, and fixed on the other end to the base plate, the stem portion extends in parallel to the first triggering axis and the second triggering axis; wherein the projected area of the pressing plate in a projection plane perpendicular to the first triggering axis and the second triggering axis is 20%-50% of the projected area of the base plate in the projection plane.

According to the present invention, the nozzle can be translated in parallel to the first triggering axis and the second triggering axis without tilting (also referred to as “parallel movement” herein), and thus multiple pumps can be triggered in a desired manner without imbalance. As such, a desired dosage ratio can be ensured. Moreover, due to proper shaping and sizing of the applicator and the nozzle, the device is easy to use, without requiring too much efforts or skills from the user to achieve the desired dosage ratio.

In an embodiment, the projected area of the pressing plate in a projection plane perpendicular to the first triggering axis and the second triggering axis is 20% to 40%, preferably 25% to 38%, preferably 28% to 37%, or preferably 30% to 36%, or preferably 32% to 36%, or preferably 35.5% of the projected area of the base plate in the projection plane.

In an embodiment, the stem portion is connected to the base plate at a central region of the base plate, and/or the stem portion is spaced from the first triggering axis by a same distance as being spaced from the second triggering axis.

In an embodiment, the projected area of the pressing plate in the projection plane perpendicular to the first triggering axis and the second triggering axis is in the range of 200-400 mm², preferably 230 mm² to 380 mm², or preferably 250 mm² to 370 mm², or preferably 280 mm² to 350 mm², or preferably 330 mm².

In an embodiment, the projected area of the base plate in the projection plane perpendicular to the first triggering axis and the second triggering axis is in the range of 860 to 1100 mm², preferably 880 mm² to 1040 mm², or preferably 900 mm² to 980 mm², or preferably 920 mm² to 940 mm², or preferably 930 mm².

In an embodiment, one of the nozzle and the main body is provided with guide bars that extend parallel to the first triggering axis and the second triggering axis, and the other one of the nozzle and the main body is provided with cooperating guide sleeves, the guide bars being configured to slide in the guide sleeves so as to guide translational movement of the nozzle relative to the main body in a direction of parallel to the first triggering axis and the second triggering axis.

In an embodiment, the guide bars have a Y-shaped cross section, and the guide sleeves define passages having a Y-shaped cross section for receiving the guide bars.

In an embodiment, the guide sleeves comprise slots extending longitudinally.

In an embodiment, the first triggering axis and the second triggering axis are parallel to a longitudinal axis of the main body.

In an embodiment, the main body has a cylindrical shape, and the first pump and the second pump are arranged at diametrically opposite positions, at a same distance from the longitudinal axis of the main body.

In an embodiment, the nozzle comprises an upper wall, a first triggering tube extending from the upper wall for triggering the first pump, and a second triggering tube extending from the upper wall for triggering the second pump.

In an embodiment, the base plate is disposed above and in contact with an upper wall of the nozzle.

In an embodiment, the pressing plate and the base plate are of flat shape or of circular shape.

In an embodiment, the main body further defines a third reservoir configured to contain a third cosmetic product, and the device further comprises a third pump configured to dispense the third cosmetic product from the third reservoir when triggered in the direction of a third triggering axis, the third triggering axis being parallel to the first triggering axis and the second triggering axis, wherein the first pump, the second pump and the third pump are arranged such that the first triggering axis, the second triggering axis and the third triggering axis are evenly spaced from each other, wherein the stem portion is spaced from the first triggering axis, the second triggering axis and the third triggering axis by a same distance.

In an embodiment, the applicator comprises an upper part and a lower part, the upper part comprising the pressing plate and an upper part protrusion, the lower part including the base plate and a lower part protrusion, wherein the stem portion is formed by the upper part protrusion and the lower part protrusion.

In an embodiment, the applicator further comprises a cylindrical applicator side wall extending from the base plate, the cylindrical applicator side wall being disposed around the nozzle and the pump.

In an embodiment, the main body comprises an outer container, an inner container and a bottom cap, the inner container and the bottom cap being disposed within the outer container.

The above and further aspects of the present disclosure will be more readily understood from the detailed description, the claims and the drawings. The detailed description and specific examples are intended for purposes of illustration only and are not intended to limit the scope of the disclosure.

### BRIEF DESCRIPTION OF THE DRAWINGS

Implementations of the present invention will now be described, by way of example only, with reference to the drawings, wherein:

FIG. 1A is a schematic perspective view of the device according to one embodiment of the present invention;

FIG. 1B is a schematic exploded view of the device according to the embodiment as shown in FIG. 1A;

FIG. 2 is a schematic sectional view of the device according to the embodiment as shown in FIG. 1A, taken along line A-A, with the nozzle in a resting position;

FIG. 3A is a schematic perspective views of the collar according to the embodiment as shown in FIG. 1A;

FIG. 3B is a further schematic perspective views of the collar according to the embodiment as shown in FIG. 1A;

FIG. 4A is a schematic perspective views of the nozzle according to the embodiment as shown in FIG. 1A;

FIG. 4B is a further schematic perspective views of the nozzle according to the embodiment as shown in FIG. 1A;

FIG. 5A is a schematic perspective view of the applicator according to the embodiment as shown in FIG. 1A;

FIG. 5B is a schematic top view of the applicator according to the embodiment as shown in FIG. 1A, with schematic representation of area T and area B;

FIG. 5C is a schematic sectional view of the applicator according to the embodiment as shown in FIG. 1A taken along line B-B;

FIG. 5D is a schematic perspective view of the upper part of the applicator according to the embodiment as shown in FIG. 1A;

FIG. 5E is a schematic perspective view of the lower part of the applicator according to the embodiment as shown in FIG. 1A;

FIG. 6A and FIG. 6B are schematic views showing the situation of the applicator during operation according to prior art;

FIG. 6C is a schematic view showing the situation of the applicator according to one embodiment of the present invention.

In the drawings, similar reference numerals may be used for denoting similar and/or identical elements. The drawings are not necessarily drawn to scale.

### DETAILED DESCRIPTION

The following description is merely exemplary in nature and is not intended to limit the present disclosure, application, or uses. Throughout the drawings, corresponding reference numerals indicate like or corresponding parts and features. It should be understood that although wordings related to directions such as “top,” “bottom” “back”, “lower”, “upper”, “left” and “right” are used with reference to the drawings or specific embodiments, there wordings are for purposes of explanation and are not intended to require specific orientations unless otherwise stated. These directions are merely provided as a frame of reference with respect to the examples provided, but could be altered in alternate applications.

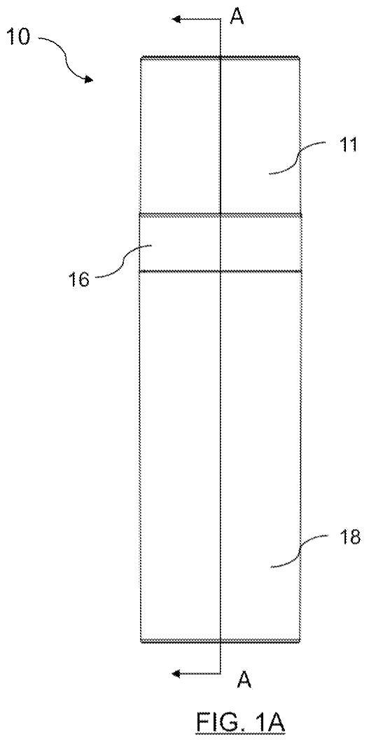

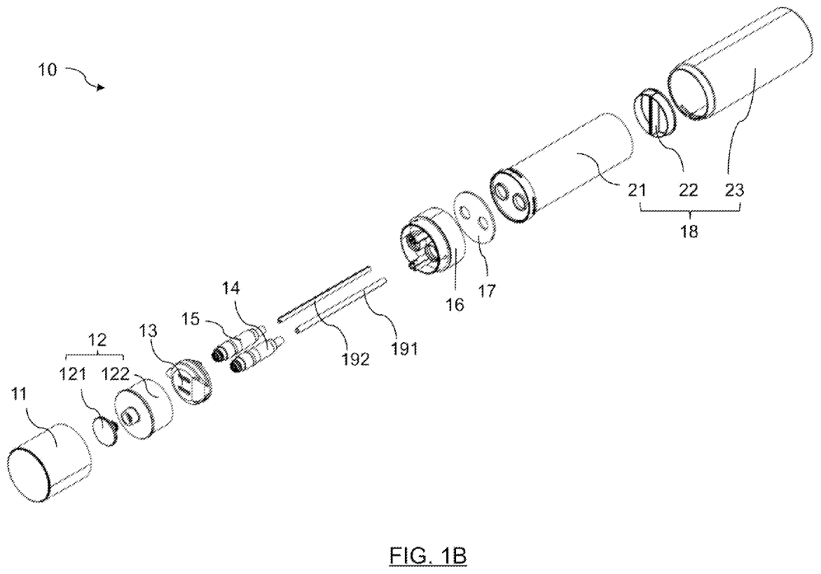

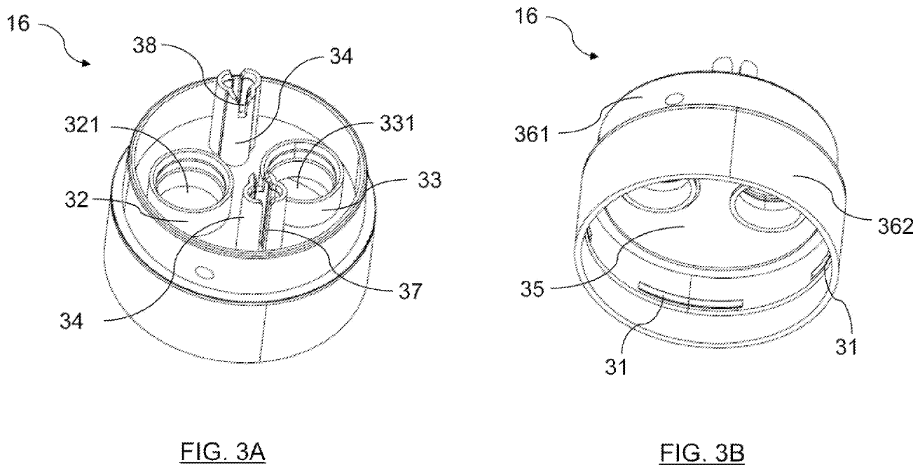

FIG. 1A is a schematic perspective view of the device 10 according to one embodiment of the present invention, FIG. 1B is a schematic exploded view thereof and FIG. 3 is schematic sectional view taken along line A-A.

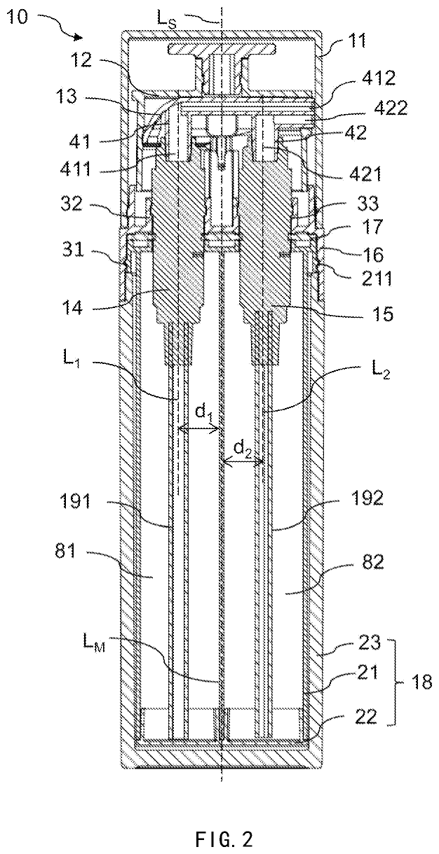

As shown in FIG. 1A-FIG. 2, the device 10 comprises a main body 18 comprising an inner container 21, a bottom cap 22 an outer container 23.

In this embodiment, the inner container 21 and the bottom cap 22 are formed as separate components that together define a first reservoir 81 and a second reservoir 82 for containing two cosmetic products. The bottom cap 22 may be fixed to the inner container 21 by press fit, ultrasonic welding, laser welding, etc., to achieve good airtightness. Alternatively, the inner container 21 and the bottom cap 22 may be integrally formed in one piece.

The device 10 comprises a collar 16 mounted on the main body 18.

As shown in FIG. 2 and FIGS. 3A-3B, the collar 16 comprises a circular collar plate 35, a cylindrical upper side wall 361 and a cylindrical lower side wall 362 extending from opposite sides of the circular collar plate 35. The diameter of the cylindrical upper side wall 361 is smaller than that of the cylindrical lower side wall 362 so as to form a step-like structure.

In the illustrated embodiment, the collar 16 comprises a plurality of grooves 31 (see FIG. 2 and FIG. 3B) provided on the inner surface of the cylindrical lower side wall 362 of the collar 16. Corresponding protrusions 211 are provided on the outer wall of the inner container 21 (see FIG. 2), for fitting into the grooves 31 and therefore fixing the collar 16 to the main body 18.

A packing 17 is disposed between the circular collar plate 35 and the inner container 21, as shown in FIG. 2, so as to facilitate airtightness of the reservoirs. The packing 17 is preferably made of an elastic material or a foaming material, especially NBR, PE, TPE, silicone rubber or EPDM, although other materials are also possible.

Referring to FIG. 3A, the collar 16 comprises a first receiving portion 32 defining a first aperture 321 for receiving a first pump 14, and a second receiving portion 33 defining a second aperture 331 for receiving a second pump 15. The collar 16 is further provided with guide sleeves 34, as will be explained in more details below.

The first pump 14 extends through the first aperture 321 and is configured to dispense the first cosmetic product from the first reservoir 81 when triggered along a first triggering axis L₁. A first sampling tube 191 is connected to the bottom of the first pump 14 for delivering the first cosmetic product contained in the first reservoir 81. The second pump 15 extends through the second aperture 331, and is configured to dispense a second cosmetic product from the second reservoir 82 when triggered along a second triggering axis L₂, the second triggering axis L₂ being parallel to the first triggering axis L₁. A second sampling tube 192 is connected to the bottom of the second pump 15 for delivering the second cosmetic product contained in the second reservoir 82. In the embodiment, the first triggering axis L₁ and the second triggering axis L₂ extend vertically and both the first and second pumps 14, 15 are triggered in a vertically downward direction.

The capacities of the pumps can be selected based on the desired dosage ratio. For example, for a desired dosage ratio of 50% vs. 50% for two cosmetic products, two identical pumps may be used. For a desired dosage ratio of 25% vs. 75%, pumps with different capacities may be selected accordingly.

In the illustrated embodiment, the first triggering axis L₁ and the second triggering axis L₂ are parallel to the longitudinal axis of the main body L_{M}, as shown in FIG. 2. In another embodiment, the first triggering axis L₁ and the second triggering axis L₂ may be inclined to the longitudinal axis of the main body L_{M}, provided that the first triggering axis L₁ and the second triggering axis L₂ are parallel to each other so that both pumps 14, 15 can be triggered in a same direction.

A nozzle 13 is disposed above the first and second pumps 14, 15 and configured to trigger both the first pump 14 and the second pump 15 at the same time. The nozzle 13 is movable relative to the main body 18 between a resting position and a discharging position, as further explained below.

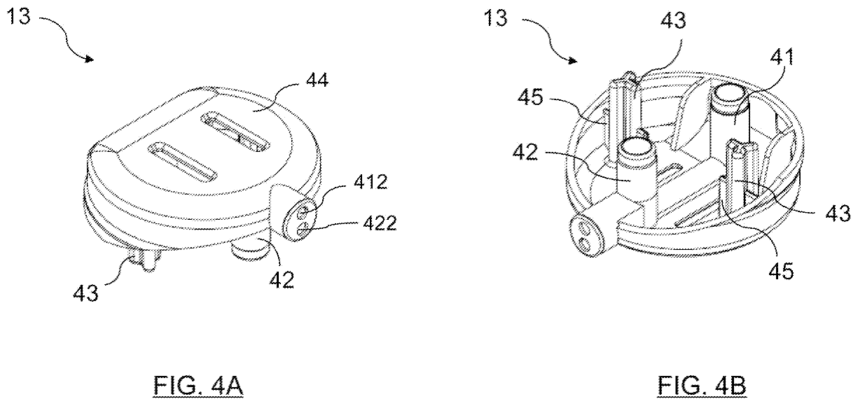

Referring to FIG. 2 and FIG. 4B, the nozzle 13 comprises a first triggering tube 41 and a second triggering tube 42 extending downwards from an upper wall 44 of the nozzle 13.

The nozzle 13 is provided with a first outlet 412 that is in fluid communication with the first pump 14 through a first channel 411 when the first pump 14 is triggered, such that the first cosmetic product that exits from the first pump 14 can be delivered through the first channel 411 and discharged from the first outlet 412. The nozzle 13 is further provided with a second outlet 422 that is in fluid communication with the second pump 15 through a second channel 421 when the second pump 15 is triggered, such that the second cosmetic product that exits from the second pump 15 can be delivered through the second channel 421 and discharged from the second outlet 422.

The nozzle 13 is biased by a biasing means towards the resting position relative to the main body 18. In the resting position, the first pump 14 and the second pump 15 are at rest and no cosmetic product can be discharged from the device 10. In the illustrated embodiment, the biasing means is formed by springs provided in the first and second pumps 14, 15. The springs bias the pistons of the pumps towards an upper, closed position and in turn bias the nozzle 13 towards an upper, resting position. Purely by way of example, the biasing force exerted by each of the pumps may be in the range of 0.8 kgf to 1.2 kgf, and the stroke of pumps may be 6.2 mm.

As shown in FIG. 1B and FIG. 2, the device 10 further comprises an applicator 12 that is configured to move the nozzle 13 relative to the main body 18 in parallel to the first triggering axis L₁ and the second triggering axis L₂ from the resting position to the discharging position against the action of the biasing means. In the discharging position, the first pump 14 and the second pump 15 are triggered and cosmetic products can be discharged from the device 10 through the first and second outlets 412, 422.

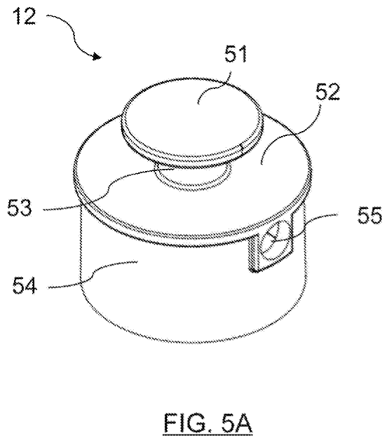

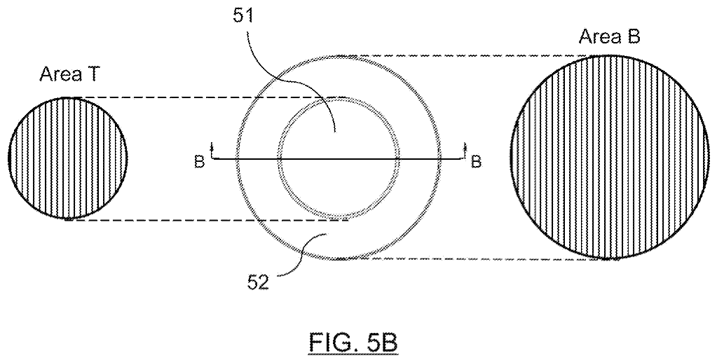

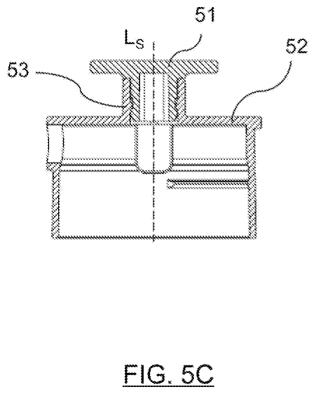

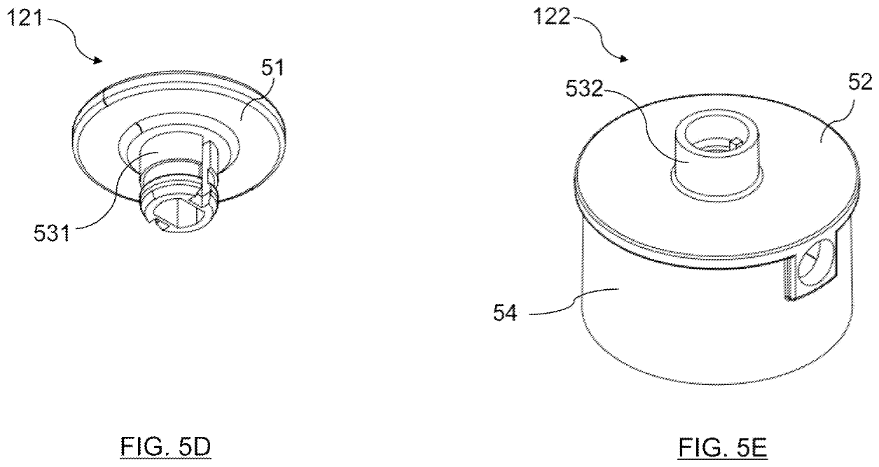

Referring to FIG. 5A-5C, the applicator 12 comprises a pressing plate 51, a base plate 52, and a stem portion 53 fixed to the base plate 52 on one end and fixed to the pressing plate 51 on the other end. The base plate 52 and the pressing plate 51 perpendicular to the first triggering axis L₁ and the second triggering axis L₂, i.e., horizontally. The stem portion 53 extends parallel to the first triggering axis L₁ and the second triggering axis L₂, i.e., vertically.

The pressing plate 51 is configured to be pressed by the user. In the embodiment, the pressing plate 51 is flat. However, it is also possible for the pressing plate 51 to be curved, e.g., having a slightly convex upper surface, as long as it allows the user to exert pressing force on the pressing plate 51 comfortably.

The base plate 52 of the applicator 12 is supported on the upper surface of the upper wall 44 of the nozzle 13, such that the pressing force exerted by the user is transmitted from the pressing plate 51 through the stem portion 53 and the base plate 52 to the nozzle 13. Optionally, the base plate 52 can be fixed to the upper wall 44 of the nozzle 13. In the embodiment, the base plate 52 is flat. However, it is also possible for the base plate 52 to be curved, as long as it allows reliable transmission of pressing force from the base plate 52 to the nozzle 13.

In the illustrated embodiment, the applicator 12 moves together with the nozzle 13. When no pressure is exerted on the applicator 12, the applicator 12 is biased together with the nozzle 13 into the resting position by the biasing means and thus no cosmetic products are discharged. When the applicator 12 is pressed by the user to move downwards, the nozzle 13 is forced to move from the resting position to the discharging position against the biasing force and accordingly cosmetic products are discharge from the device 10.

The base plate 52 has a circular shape and the stem portion 53 extends from a central region of the base plate 52. The pressing plate 51 of the applicator 12 also has a circular shape the upper end of the stem portion 53 is fixed in a central region of pressing plate 51. It is to be understood that although shown as being circular in the exemplary embodiment, the base plate 52 and the pressing plate 51 can also have other shapes, such as being rectangular, hexagonal, oval, etc.,

In the illustrated embodiment, the first pump 14 and the second pump 15 are arranged at diametrically opposite positions with a substantially same distance from the longitudinal axis of the main body L_{M}, and the stem portion 53 is substantially aligned with the longitudinal axis of the main body L_{M}. The stem portion 53 is positioned in a middle position between the two pumps 14, 15, spaced from the first triggering axis L₁ by a distance d₁ and spaced from the second triggering axis L₂ by a distance d₂ (see FIG. 2). As shown in FIG. 2, the distance d₁ is substantially equal to the distance d₂. As used herein, the distance between the stem portion 53 and the first triggering axis L₁ may refer to the distance between the longitudinal axis of the stem portion L_{S} (see FIG. 2 and FIG. 5C) to and the first triggering axis L₁. In the illustrated embodiment where a dosage ratio of 50% vs. 50% is desired, the longitudinal axis of the stem portion L_{S} coincides with the longitudinal axis of the main body L_{M}.

In other embodiments, especially where the first pump 14 is not identical to the second pump 15, the position of the stem portion 53 may be slightly adjusted around the center of the base plate 52, so as to adapt to differences between the pumps. For example, in the case that a dosage ratio of 25% vs. 75% is desired, the longitudinal axis of the stem portion L_{S} may deviate from the center of the base plate 52 or from longitudinal axis of the main body L_{M} by a distance of no more than 5 mm, preferably no more than 3 mm.

As used herein, the wording “central region” is understood as referring to a confined area generally around the center, but not necessarily limited to merely an exact geometrical center point. Therefore, in the case that the stem portion 53 is slightly adjusted in position so as to adapt to different pump properties, it may still be in a central region of the base plate 52 in the sense of the present invention.

The inventors of the present invention have found that by proper sizing and positioning of the pressing plate 51, the base plate 52 and the stem portion 53, a desired dosage ratio can be achieved while ensuring user comfort at the same time.

Referring to FIG. 5B, a top view of the applicator 12 is shown in the middle. The projected area of the pressing plate 51 in a projection plane perpendicular to the first triggering axis L₁ and the second triggering axis L₂ is shown on the left-hand side as “area T”, and the projected area of the base plate 52 in the projection plane perpendicular to the first triggering axis L₁ and the second triggering axis L₂ is shown on the right-hand side as “area B”. In this embodiment, the projection plane is a horizontal plane, since the first triggering axis L₁ and the second triggering axis L₂ are arranged vertically.

According to the present invention, the area T substantially corresponds to the fingerprint size of an index finger of the user. In the illustrated embodiment, the area T is around 330 mm², corresponding to a diameter of 20.5 mm². In other embodiments, the area T of the pressing plate 51 may be in the range of 200 to 400 mm², preferably 230 mm² to 380 mm², or preferably 250 mm² to 370 mm², or preferably 280 mm² to 350 mm².

According to the present invention, the area B for the base plate 52 is large enough to cover the elements for actuating both the first pump 14 and the second pump 15. In the illustrated embodiment, the area B covers both the first triggering tube 41 and the second triggering tube 42. On the other hand, the area B for the base plate 51 may not be overly large, so that the user can hold the device 10 easily in his/her hand. In the illustrated embodiment, the area B is around 930 mm², corresponding to a diameter of around 34.4 mm. In other embodiments, the area B of the base plate 52 may be in the range of 860 to 1100 mm², preferably 880 mm² to 1040 mm², or preferably 900 mm² to 980 mm², or preferably 920 mm² to 940 mm².

According to the present invention, the projected area T of the pressing plate 51 is 20% to 50% of the projected area B of the base plate 52, being preferably 25% to 40%, or preferably 25% to 38%, or preferably 28% to 37%, or preferably 30% to 36%, or preferably 32% to 36% of the projected area B of the base plate 52. In the embodiment according to FIG. 1A, the area T is approximately 35.5% of the area B.

By way of example, some preferable values for the projection area T of the pressing plate 52 and the projection area B of the pressing plate 51 is provided below in Table 1.

TABLE 1
Preferred values for areas T and B

| Area T (mm²) | Area B (mm²) | T/B (%) |
|---|---|---|
| 240 | 910 | 26.4 |
| 260 | 910 | 28.6 |
| 280 | 910 | 30.8 |
| 300 | 910 | 33.0 |
| 320 | 910 | 35.2 |
| 330 | 910 | 36.3 |
| 340 | 910 | 37.4 |
| 300 | 930 | 32.3 |
| 320 | 930 | 34.4 |
| 330 | 930 | 35.5 |
| 340 | 930 | 36.6 |
| 300 | 960 | 31.3 |
| 320 | 960 | 33.3 |
| 330 | 960 | 34.4 |
| 340 | 960 | 35.4 |
| 350 | 960 | 36.5 |

The stem portion 53 has a smaller diameter as compared to the pressing plate 51. In the illustrated embodiment, the stem portion 53 has a cylindrical shape. Preferably, the diameter of the stem portion 53 is 35% to 75% of the diameter of the pressing plate 51, or preferably 50% to 65%, or preferably 55% to 60%. The diameter of the stem portion 53 may be in the range of from 4 mm to 13 mm, preferably 5 mm to 13 mm, or preferably 6 mm to 11 mm, or preferably 7 mm to 10 mm. The axial length of the stem portion 53 is preferably 5 mm to 13 mm, or preferably 6 mm to 11 mm, or preferably 7 mm to 10 mm. A suitable sizing of the stem portion 53 on the one hand effectively prevents the pressing finger of the user from contacting the base plate 53, and on the other hand contributes to reliable force transmission at a central region of the applicator 12.

In the illustrated embodiment, the applicator 12 is formed by an upper part 121 as shown in FIG. 5D, and a lower part 122 as shown in FIG. 5E. The upper part 121 comprises the pressing plate 51 and an upper part protrusion 531 extending from the bottom of the pressing plate 51 at a central region thereof. The lower part 122 comprises the base plate 52 and a lower part protrusion 532 extending from the base plate 52 at a central region thereof. The lower part protrusion 532 has a tubular shape. The upper part protrusion 531 is inserted into the lower part portion 532 and fixed thereto as shown in FIG. 5C. The stem portion 53 is thereby formed by the protrusion 531 together with the tubular portion 532.

In the embodiment, both the upper part 121 and the lower part 122 of the applicator 12 are made of PP material, although other materials are also possible.

The two-part design according to this embodiment is advantageous since it facilitates decoration of the applicator 12. However, it is also conceivable to form the applicator 12 in one piece.

As shown in FIG. 3 and FIG. 5A, the applicator 12 further comprises a cylindrical side wall 54 that is inserted on its lower end into the collar 16 and that surrounds the nozzle 13 and the pumps 14, 15. An opening 55 aligned with the first and second outlets 412, 422 is provided in the applicator side wall 54 to enable dispensing of the cosmetic products from the device 10. Such an applicator 12 provides further protection for the nozzle 13 and the pumps 14, 15 against contamination and contributes to an aesthetically pleasant appearance of the device 10.

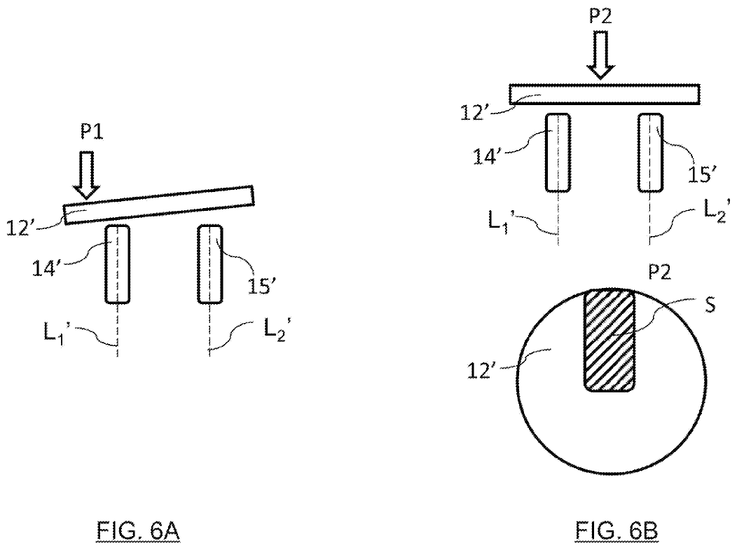

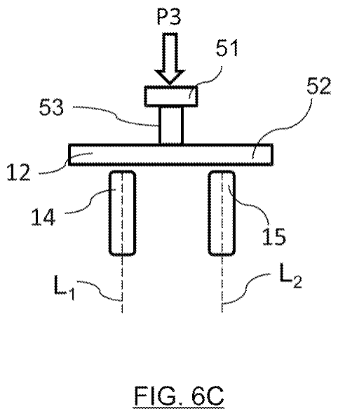

The special design of applicator according to the present invention makes it possible to improve comfort of use while at the same time restrict the application of pressure to a proper position, thereby avoiding tilting of the applicator and ensuring a proper dosage ratio. The advantage of the present invention will be further explained with reference to FIGS. 6A-6C.

FIG. 6A-6B are schematic views for illustrating the situation of a prior art device. According to prior art, when the user presses on one side of the applicator 12′ (see e.g., position P1 in FIG. 6A), the applicator 12′ and also the nozzle (not shown) are tilted. In this case the nozzle does not move in parallel to the first triggering axis L₁′ and the second triggering axis L₂′, and the elements for triggering the two pumps 14′, 15′ are not displaced by a same distance, leading to incorrect dosage ratio. Even if the user tries to press the applicator 12′ at a central position by putting his/her fingertip at the center (see e.g., position P2 in FIG. 6B), imbalance is still likely to occur since the other portion of the finger will be in contact with the applicator 12′ on only one side. The shaded area S in FIG. 6B schematically shows the area in contact with and pressed by the finger as viewed from above. Accordingly, a precise dosage ratio is hard to achieve for prior art.

FIG. 6C a schematic view illustrating the situation of the present invention. As shown in FIG. 6C, the user presses on the pressing plate 51 and the pressing force is transmitted through the stem portion 53 to a central region of the base plate 52. The base plate 52 and in turn the nozzle perform translational movement parallel to the first triggering axis L₁ and the second triggering axis L₂ without tilting (also referred to as “parallel movement” herein), and thus the pumps 14, 15 are properly triggered. In this way, the user can dispense different cosmetic products in a proper dosage ratio with little effort.

According to the present invention, the parallel translational movement the nozzle 13 is further enhanced by cooperating guide bars 43 and guide sleeves 34 provided on the nozzle 13 and on the collar 16, respectively.

As shown in FIG. 3A, two guide sleeves 34 extend vertically upwards from the collar plate 35 in parallel. Referring to FIG. 4B, two guide bars 43 extend vertically downwards from the bottom of the upper wall 44 of the nozzle 13 in parallel. The guide bars 43 are configured to be inserted into respective guide sleeves 34 and slide therein.

In the illustrated embodiment, the guide bars 43 have a Y-shaped cross section having three legs, and the guide sleeves 34 define passages having Y-shaped cross section for receiving the guide bars 43. The Y shaped guide bars 43 according to the present invention are particularly advantageous for preventing tilting of the nozzle 13 as compared to conventional circular or rectangular shaped guide bars. Preferably, the upper wall 44 of the nozzle 13 has a substantially circular projection area in a projection plane parallel to the first triggering axis L₁ and the second triggering axis L₂, and one of the three legs of each of the Y-shaped guide bars 43 are oriented radially towards the center of the nozzle 13.

The sleeves 34 are each provided with a slot 37 that extends longitudinally. The slot 37 is provided on the side facing away from the center of the collar 16. Moreover, the sleeves are each provided with a longitudinal notch 38 facing the center of the collar 16. The slots 37 and the notches 38 serve as a guide for two guide fins 45 extending from opposite sides of the guide bar 43, as shown in FIG. 4B. This further ensures proper orientation and alignment between the guide bars 43 and the guide sleeves 34. Also, it facilitates fitting of the guide bar 43 into the sleeve 34 without compromising reliable guidance of parallel movement. Preferably, the slot 37 extends over the entire length of the sleeve 34 for easier molding.

An over cap 11 is provided to cover and protect the applicator 12 and the nozzle 13 from the environment. The over cap 11 can be easily mounted onto the main body 18 by snap fit.

Although two reservoirs and two pumps are provided in the illustrated embodiment, it is also possible to provide three or more reservoirs with three or more pumps, if appropriate. In an embodiment, three pumps may be arranged to be evenly spaced from each other around the longitudinal axis L_{M} of the main body 18, and the stem portion 53 of the applicator 12 may be arranged in parallel to the triggering axes of the three pumps and having an equal distance thereto. The stem portion 53 is fixed to the pressing plate 51 at a central region thereof and to the base plate 52 at a central region, so that the three pumps can be triggered easily in parallel.

Although the present invention has been described in terms of exemplary embodiments, it not limited thereto. The detailed description is to be construed as exemplary only and does not describe every possible embodiment of the present disclosure. Numerous alternative embodiments could be implemented, using either current technology or technology developed after the filing date of this patent that would still fall within the scope of the claims defining the invention(s) disclosed herein.

Those skilled in the art will recognize that a wide variety of modifications, alterations, and combinations can be made with respect to the above described embodiments without departing from the spirit and scope of the invention(s) disclosed herein, and that such modifications, alterations, and combinations are to be viewed as being within the ambit of the inventive concept(s).

### LIST OF REFERENCE NUMERALS

10 device for storing and dispensing at least two cosmetic products
11 over cap
12 applicator
121 upper part of applicator
122 lower part of applicator
13 nozzle
14 first pump
15 second pump
16 collar
17 packing
18 main body
191 first sampling tube
192 second sampling tube
21 inner container
211 protrusion
22 bottom cap
23 outer container
31 groove
32 first receiving portion
321 first aperture
33 second receiving portion
331 second aperture
34 guide sleeve
35 collar plate
361 upper side wall
362 lower side wall
37 slot
38 notch
41 first triggering tube
411 first channel
412 first outlet
42 second triggering tube
421 second channel
422 second outlet
43 guide bar
44 upper wall of the nozzle
45 guide fin
51 pressing plate
52 base plate
53 stem portion
531 upper part protrusion
532 lower part protrusion
54 applicator side wall
55 opening
L₁ first triggering axis
L₂ second triggering axis
L_{M} longitudinal axis of the main body
L_{S} longitudinal axis of the stem portion
81 first reservoir
82 second reservoir

1. A device for storing and dispensing at least two cosmetic products, comprising:
a main body defining a first reservoir configured to contain a first cosmetic product and a second reservoir configured to contain a second cosmetic product;
a first pump configured to dispense the first cosmetic product from the first reservoir when triggered along a first triggering axis;
a second pump configured to dispense the second cosmetic product from the second reservoir when triggered along a second triggering axis, the second triggering axis being parallel to the first triggering axis;
a nozzle defining a first outlet in fluid communication with the first pump through a first channel and a second outlet in fluid communication with the second pump through a second channel, wherein the nozzle is movably arranged relative to the main body and biased towards a resting position relative to the main body by a biasing means;
an applicator operable to move the nozzle relative to the main body parallel to the first triggering axis and the second triggering axis, from a resting position, in which the first pump and the second pump are at rest, into a discharging position, in which the first pump and the second pump are triggered, against the action of the biasing means;
wherein the applicator comprises:
a pressing plate configured to be pressed by a user;
a base plate configured for pushing the nozzle;
a stem portion fixed on one end to the pressing plate at a central region of the pressing plate, and fixed on the other end to the base plate, the stem portion extends in parallel to the first triggering axis and the second triggering axis;
wherein the projected area of the pressing plate in a projection plane perpendicular to the first triggering axis and the second triggering axis is 20%-50% of the projected area of the base plate in the projection plane.

2. The device according to claim 1, wherein the projected area of the pressing plate in a projection plane perpendicular to the first triggering axis and the second triggering axis is 20% to 40% preferably 25% to 38%, preferably 28% to 37%, or preferably 30% to 36%, or preferably 32% to 36%, of preferably 35.5% of the projected area of the base plate in the projection plane.

3. The device according to claim 1, wherein the stem portion is connected to the base plate at a central region of the base plate, and/or the stem portion is spaced from the first triggering axis by a same distance as being spaced from the second triggering axis.

4. The device according to claim 1, wherein the projected area of the pressing plate in the projection plane perpendicular to the first triggering axis and the second triggering axis is in the range of from 200 mm² to 400 mm².

5. The device according to claim 1, wherein the projected area of the base plate in the projection plane perpendicular to the first triggering axis and the second triggering axis is in the range of 860 mm² to 1100 mm².

6. The device according to claim 1, wherein one of the nozzle and the main body is provided with guide bars that extend parallel to the first triggering axis and the second triggering axis, and the other one of the nozzle and the main body is provided with cooperating guide sleeves, the guide bars being configured to slide in the guide sleeves so as to guide translational movement of the nozzle relative to the main body in a direction of parallel to the first triggering axis and the second triggering axis.

7. The device according to claim 6, wherein the guide bars have a Y-shaped cross section, and the guide sleeves define passages having a Y-shaped cross section for receiving the guide bars.

8. The device according to claim 6, wherein the guide sleeves comprise slots extending longitudinally.

9. The device according to claim 1, wherein the first triggering axis and the second triggering axis are parallel to a longitudinal axis of the main body.

10. The device according to claim 1, wherein the main body has a cylindrical shape, and the first pump and the second pump are arranged at diametrically opposite positions, at a same distance from the longitudinal axis of the main body.

11. The device according to claim 1, wherein the nozzle comprises an upper wall, a first triggering tube extending from the upper wall for triggering the first pump, and a second triggering tube extending from the upper wall for triggering the second pump.

12. The device according to claim 1, wherein the base plate is disposed above and in contact with an upper wall of the nozzle.

13. The device according to claim 1, wherein the pressing plate and the base plate are of flat shape or of circular shape.

14. The device according to claim 1, wherein the main body further defines a third reservoir configured to contain a third cosmetic product, and the device further comprises a third pump configured to dispense the third cosmetic product from the third reservoir when triggered in the direction of a third triggering axis, the third triggering axis being parallel to the first triggering axis and the second triggering axis, wherein the first pump, the second pump and the third pump are arranged such that the first triggering axis, the second triggering axis and the third triggering axis are evenly spaced from each other, wherein the stem portion is spaced from the first triggering axis, the second triggering axis and the third triggering axis by a same distance.

15. The device according to claim 1, wherein the applicator comprises an upper part and a lower part, the upper part comprising the pressing plate and an upper part protrusion, the lower part including the base plate and a lower part protrusion, wherein the stem portion is formed by the upper part protrusion and the lower part protrusion.

16. The device according to claim 1, wherein the applicator further comprises a cylindrical applicator side wall extending from the base plate, the cylindrical applicator side wall being disposed around the nozzle and the pump.

17. The device according to claim 1, wherein the main body comprises an outer container, an inner container and a bottom cap, the inner container and the bottom cap being disposed within the outer container.
